(19) United States
(12) Patent Application Publication
(10) Pub. No.: US 2008/0239248 A1
(43) Pub. Date: Oct. 2, 2008

(54) DISPLAY ILLUMINATION APPARATUS

(75) Inventors: Hisayuki Mihara, Honjo-shi (JP); Kohei Watanabe, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/050,554

(22) Filed: Mar. 18, 2008

(30) Foreign Application Priority Data
Mar. 30, 2007 (JP) 2007-095340

(51) Int. Cl. G03B 21/20

(52) U.S. Cl. 353/85

(57) ABSTRACT

According to one embodiment, an illumination apparatus for a display includes first and second light sources, a lighting control unit which lights the first and second light sources successively, and a light path switching unit which switches light paths between each of the light sources and a projection lens among a first state in which light from the first light source of the first and second light sources is emitted to the projection lens, a second state in which light from the second light source of the first and second light sources is emitted to the projection lens, and a third state in which light from either one of the first and second light sources is emitted to the projection lens.

### CROSS-REFERENCE TO RELATED APPLICATIONS

This application is based upon and claims the benefit of priority from Japanese Patent Application No. 2007-095340, filed Mar. 30, 2007, the entire contents of which are incorporated herein by reference.

### BACKGROUND

1. Field

One embodiment of the present invention relates to a display illumination apparatus using light-emitting diodes as light sources.

2. Description of the Related Art

As a typical conventional display illumination apparatus used for a digital light processing (DLP) type projector or the like, there is generally provided an apparatus comprising a discharge lamp such as a high pressure mercury lamp, metal halide lamp, or xenon lamp and a reflector which controls/reflects applied light in an arbitrary direction. In order to reduce light amount irregularity on an irradiation surface, some of such illumination apparatuses have an integration function using, for example, a light tunnel or a pair of fly-eye lenses, i.e., a function of superimposing/focusing a plurality of illumination regions each having a predetermined shape sampled/shaped by an optical device on an illumination target. In addition, an apparatus using light-emitting diodes (LEDs) as light sources has recently been formed.

As an illumination apparatus using light-emitting diodes as light sources, there is available an apparatus which comprises a disk mirror having a transmission region and a reflection region at the intersecting position between the optical axes of two light sources whose exit primary optical axes are perpendicular to each other and switches the positions of the transmission and reflection regions by rotating the mirror in synchronism with the emission of light from the light sources in order to increase the light amount, as disclosed in, for example, Jpn. Pat. Appln. KOKAI Publication No. 2006-39277.

In a period of transition between a state wherein light from one light source is reflected and a state wherein light from the other light source is transmitted, the boundary between the transmission region and the reflection region is included in the intersection region between light beams from the respective light sources. Conventionally, in these region switching periods, light beams from the two light sources mix with each other and strike the light bulb, and hence neither of the light sources is made to emit light if the efficiency precedes over others.

As described above, since no illumination light is applied to the light bulb during periods in which light beams from the two light sources mix, a single-chip digital light processing (DLP) system which performs tone expression based on PWM driving, in particular, cannot implement sufficient tone expression. For this reason, this mixing system is low in quality and hence not practical. The luminance of an LED is weak as a light source for a projector. Therefore, the application range of a projector using LEDs as light sources is very limited if the efficiency precedes over others.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a plan view showing an example of the arrangement of a general display illumination apparatus;

FIG. 2 is a plan view showing the first modification of the light sources of the general display illumination apparatus;

FIG. 3 is a plan view showing the second modification of the light sources of the general display illumination apparatus;

FIG. 4 is a timing chart of the general display illumination apparatus which shows the tone expression principle based on incident light and PWM when a single-chip digital mirror device (DMD) is used as a light bulb;

FIG. 5 is a plan view showing an example of the arrangement of a display illumination apparatus using a discharge tube as a light source;

FIG. 6 is a timing chart of the general display illumination apparatus which shows the tone expression principle based on incident light and PWM when a discharge tube is used as a light source;

FIG. 7 is a plan view showing an example of the mirror wheel of a display illumination apparatus according to the first embodiment of the present invention;

FIG. 8 is a plan view showing an example of the overall arrangement of the display illumination apparatus according to the first embodiment of the present invention;

FIG. 9 is a timing chart showing the relationship between the emission period of each light source, the switching state of the respective regions of the mirror wheel, and the emission state of combined light of the display illumination apparatus according to the first embodiment of the present invention;

FIG. 10 is a plan view showing an example of the mirror wheel of a display illumination apparatus according to the second embodiment of the present invention;

FIG. 11 is a plan view showing an example of the overall arrangement of the display illumination apparatus according to the second embodiment of the present invention;

FIG. 12 is a timing chart showing the relationship between the emission period of each light source, the switching state of the respective regions of the mirror wheel, and the emission state of combined light of the display illumination apparatus according to the second embodiment of the present invention;

FIG. 13 is a plan view showing an example of the overall arrangement of a display illumination apparatus according to the third embodiment of the present invention;

FIG. 14 is a timing chart showing the relationship between the emission period of each light source, the switching state of the respective regions of the mirror wheel, and the emission state of combined light of the display illumination apparatus according to the third embodiment of the present invention;

FIG. 15 is a plan view showing an example of the overall arrangement of a display illumination apparatus according to the fourth embodiment of the present invention;

FIG. 16 is a plan view showing an example of the overall arrangement of a display illumination apparatus according to the fifth embodiment of the present invention;

FIG. 17 is a plan view showing a first example of the mirror wheel of a display illumination apparatus according to the fifth embodiment of the present invention;

FIG. 18 is a plan view showing a second example of the mirror wheel of a display illumination apparatus according to the fifth embodiment of the present invention;

FIG. 19 is a timing chart showing the relationship between the emission period of each light source, the switching state of the respective regions of the mirror wheel, and the emission state of combined light of the display illumination apparatus according to the fifth embodiment of the present invention;

FIG. 20 is a diagram showing an example of the light emission conditions of each light source, and filter property conditions of the display illumination apparatus according to the fifth embodiment of the present invention; and

FIG. 21 is a diagram showing an example of the characteristics of the light emission efficiency of each light source of the display illumination apparatus according to the fifth embodiment of the present invention.

### DETAILED DESCRIPTION

Various embodiments according to the invention will be described hereinafter with reference to the accompanying drawings. In general, according to one embodiment of the invention, a display illumination apparatus includes a first light source which emits each of light beams of three primary colors for an arbitrary period in a predetermined period, a second light source which emits each of the light beams of three primary colors for an arbitrary period in an arbitrary period different from the first light source emission period, with applied light intersecting applied light from the first light source, a light bulb which receives light from one of the first light source and the second light source and outputs the light to a projection lens, an optical member which is placed in an intersection region between light from the first light source and light from the second light source and on which a first region having a property of reflecting predetermined light from the first light source, a second region having a property of reflecting light of an arbitrary color from the first light source and transmitting light of a different arbitrary color from the second light source, a third region having a property of transmitting light from the second light source, and a fourth region having a property of transmitting light of an arbitrary color from the second light source and reflecting light of a different arbitrary color emitted from the first light source are arbitrarily arranged in a disk form and rotation control means for rotating the optical member to reflect light from the first light source toward the light bulb at the time of emission of light from the first light source, and locating each region of the optical member at an intersecting position between light from the first light source and light form the second light source so as to transmit light from the second light source toward the light bulb at the time of emission of light from the second light source.

To readily understand the characteristic features of the present invention, a general display apparatus using light-emitting diodes as light sources will be described first.

FIG. 1 is a plan view showing an example of the arrangement of a general display illumination apparatus.

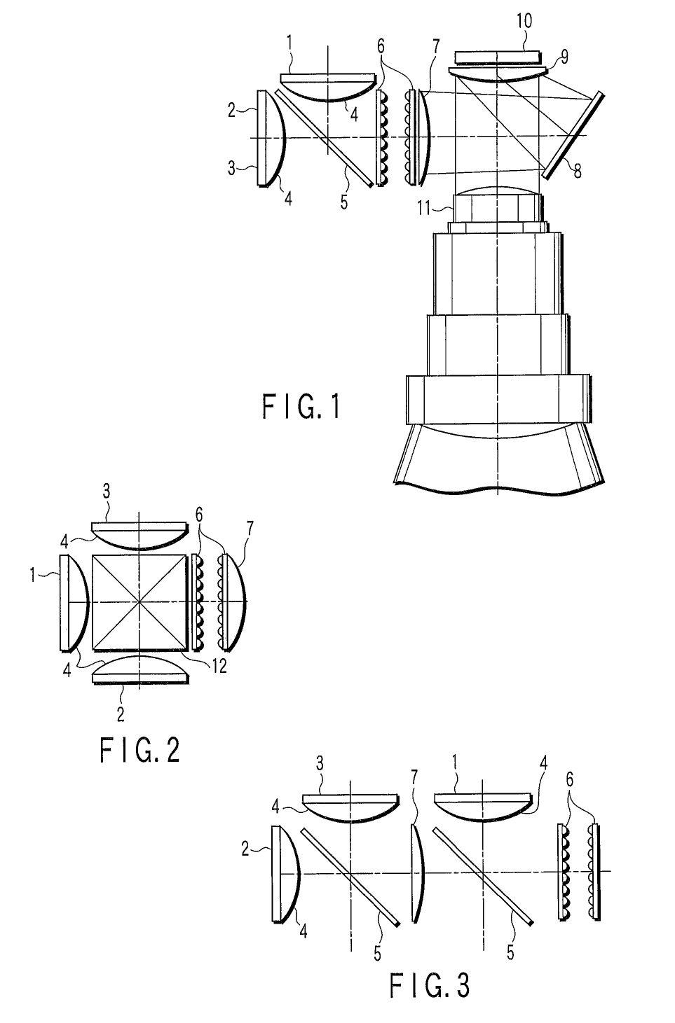

The general display illumination apparatus shown in FIG. 1 comprises a green light source 1 which is a green LED light source, a red light source 2 which is a red LED light source, and a blue light source 3 which is a blue LED light source. In this display illumination apparatus, the green light source 1 is independently placed, and the red light source 2 and blue light source 3 are arranged side by side. As shown in FIG. 2, however, all the light sources are sometimes independently arranged by using a cross prism 12.

A collimator lens 4 for performing light cutoff control is mounted on the emission surface of the green light source 1, which is an exit side, and another collimator lens 4 is mounted on the emission surface of the red light source 2 and blue light source 3.

A dichroic filter 5 for combining light beams from the green light source 1, red light source 2, and blue light source 3 into white light is provided at the intersecting position between the optical axes of the respective light beams. The dichroic filter 5 tilts by 45° with respect to the optical axes of light beams from the green light source 1 and the red light source 2 or the blue light source 3.

A fly-eye lens 6 comprising two lenses is placed at the end of the dichroic filter 5, when viewed from the collimator lens 4 on the red light source 2/blue light source 3 side, so as to be parallel to the collimator lens 4.

A condenser lens 7 is mounted on the exit side of the fly-eye lens 6 to apply superimposed/averaged illumination light to a light bulb 10 by using a reflecting mirror 8 and a field lens 9.

When the light bulb 10 is on, applied light passes through the field lens 9 and is guided to a projection lens 11. When the light bulb 10 is off, applied light is guided to an arbitrary light-shielding region (not shown).

FIG. 3 is a plan view showing the second modification of the light source of the general display illumination apparatus.

In this modification, as in the first modification, the green light source 1, red light source 2, and blue light source 3 are independently arranged so as to make light beams from the red light source 2 and the blue light source 3 almost perpendicular to each other. This modification combines light beams by using the dichroic filter 5, and combines a light beam from the green light source 1, which is almost perpendicular to the combined light, again by using the dichroic filter 5.

The collimator lens 4 is mounted on the exit side of each light source. Placing the condenser lens 7 for combined light from the red light source 2 and the blue light source 3 to make combining conditions uniform.

The fly-eye lens 6 is placed at an end of the dichroic filter 5.

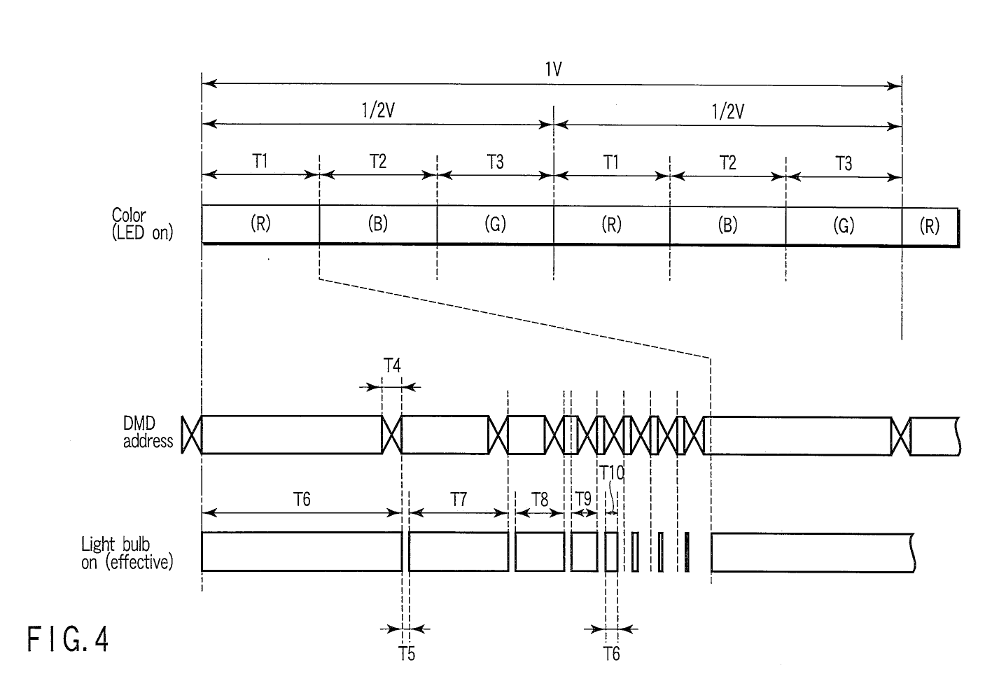

FIG. 4 is a timing chart of the general display illumination apparatus which shows the tone expression principle based on incident light and PWM when a single-chip digital mirror device (DMD) is used as a light bulb.

When the light sources of the respective colors of the general display illumination apparatus are LED light sources, the apparatus performs emitted light color separation along the time axis by selectively driving the light sources so as to sequentially select or switch the three primary colors of light in synchronism with video signals or make the light sources arbitrarily emit light beams. In accordance with this operation, the light bulb 10 performs PWM driving for tone expression in accordance with the selected colors, i.e., the illumination light colors, of video signals, thereby displaying a color video picture by using the integrating effect of the human eye.

More specifically, for example, as shown in FIG. 4, when color sequential display is to be performed in, for example, a double cycle to make color separation unnoticeable in the period of a video signal field 1V, light of the three primary colors is emitted twice at an arbitrary distribution period ratio in consideration of white balance.

In the case shown in FIG. 4, the red light source 2 emits light for time T1, and the blue light source 3 emits light for time T2 from the end of red light emission. The green light source 1 emits light for time T3 from the end of blue light emission. This apparatus performs light emission again in this order.

In each color period, for example, in time T1, the light bulb 10 performs PWM driving in accordance with a video signal. In this case, the light bulb 10 becomes effective after address switching in an address period T4 and a DMD mirror switching period T5 (not shown). Such effective periods are set at address switching intervals in switching order, i.e., a first effective period T6, second effective period T7, third effective period T8, fourth effective period T9, and fifth effective period T10 (ditto for the following). In this case, light bulb on-periods corresponding to the respective bits obtained by binarizing a video signal level are set at the ratio of power of 2 to control the light amount and express brightness by the integrating effect of the human eye.

Note that when an on-period of the light bulb is shorter than an address period, the light bulb is turned off at once by a reset pulse.

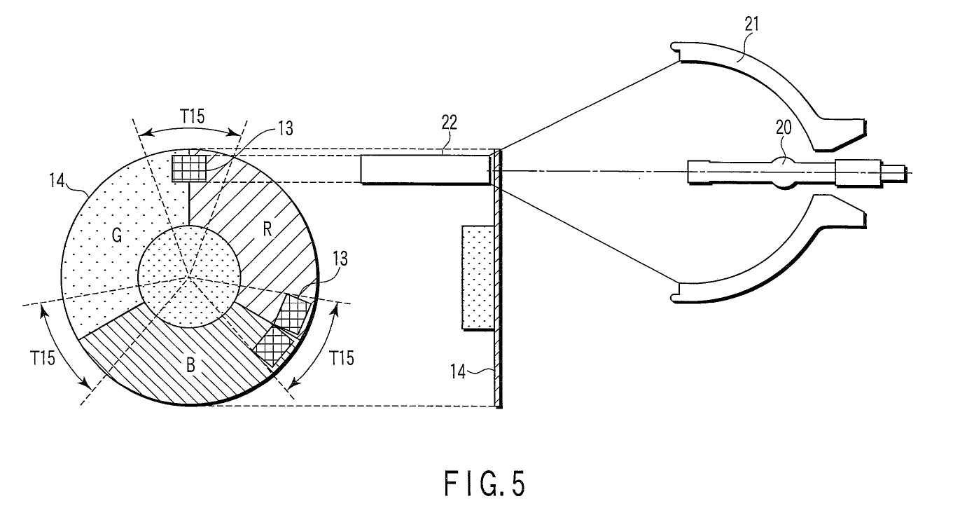

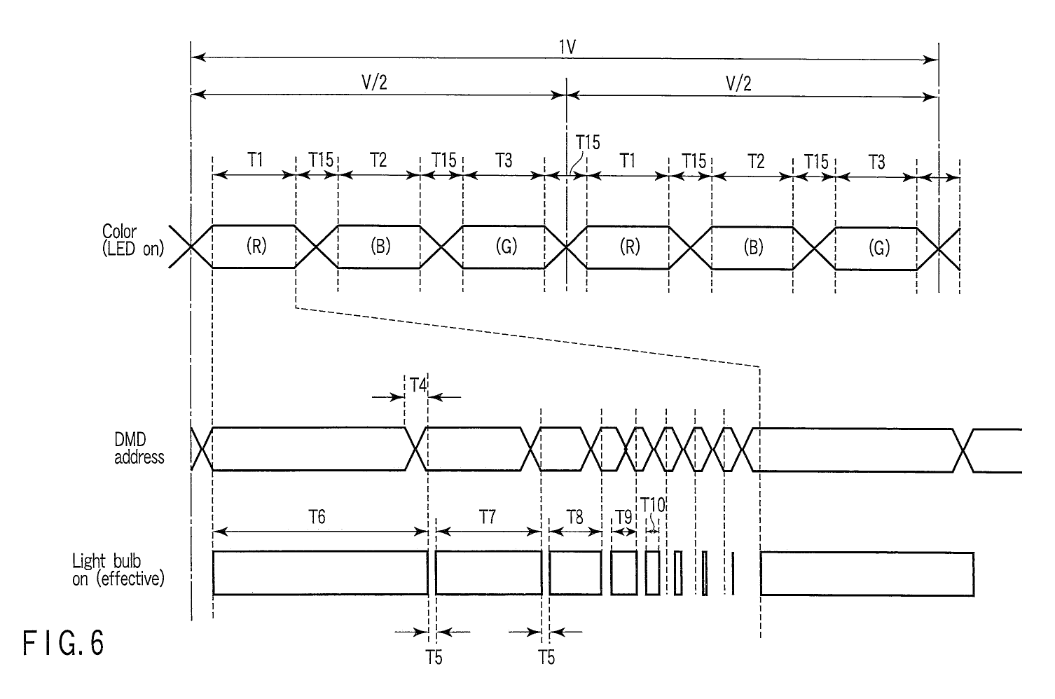

When a discharge tube is to be used as a light source, a reflector 21 focuses light from a light source 20 shown in FIG. 5 onto a light tunnel 22. A color wheel 14 placed near the light tunnel 22 then sequentially selects and illuminates three primary colors of light. However, since the range in which each dichroic mirror boundary of the color wheel 14 intersects the region in which focused light from the reflector 21 reaches the light tunnel 22 includes a period T15 in which light beams of two colors which have passed through different dichroic mirrors mix with each other, the light beams cannot be used for tone expression of the three primary colors of light. FIG. 6 shows this state. A region of the color wheel 14 to which the light source 20 applies light in the period T15 will be referred to as a limited light concentration range hereinafter. The color wheel 14 will be referred to as a CW 14 hereinafter.

Assume that in order to reduce an uncomfortable feeling produced at the time of color switching, the number of revolutions of the CW 14 is increased or that a sequence period is shortened due to conditions for the maintenance of white balance, and satisfactory tone expression cannot be achieved because of conditions for the address period T4 and the switching period T5 which are determined by the ability of the light bulb. In this case, it suffices to perform tone expression by FRC driving across the emission periods T1, T2, and T3 of the respective light sources and the next subfield, i.e., periods T1, T2, and T3 after ½V.

### FIRST EMBODIMENT

The first embodiment of the present invention will be described next.

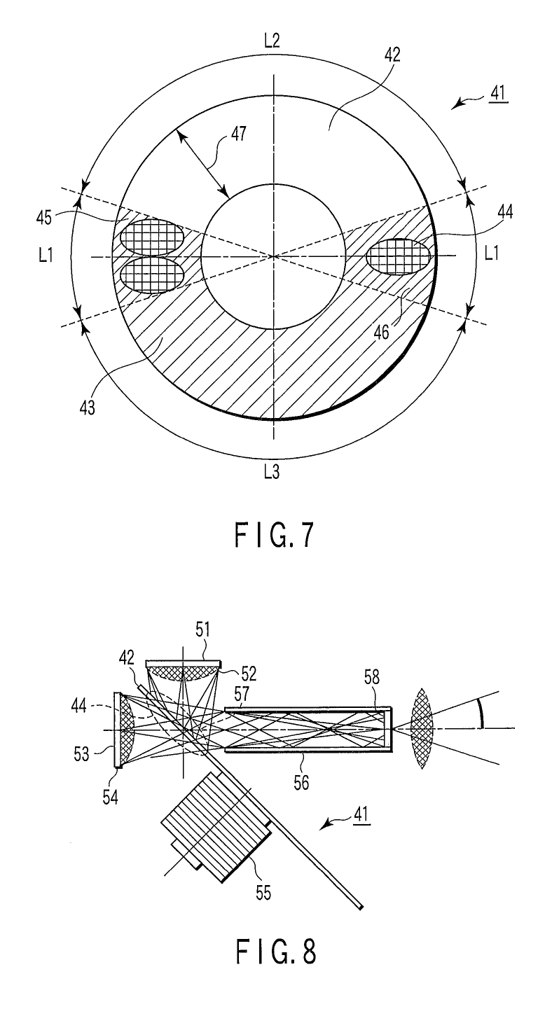

FIG. 7 is a plan view showing an example of the mirror wheel of a display illumination apparatus according to the first embodiment of the present invention.

FIG. 8 is a plan view showing an example of the overall arrangement of the display illumination apparatus according to the first embodiment of the present invention.

For the sake of simplicity, unlike FIGS. 1, 2, and 3, the drawing showing this embodiment shows an arrangement which performs superimposition/averaging by using a light tunnel instead of a fly-eye lens. A unit which combines light beams from three primary color light sources comprising dichroic mirrors and other optical means will not be illustrated. The drawing shows this arrangement as one light source after color combining operation.

As shown in FIG. 7, a mirror wheel 41 which is an optical member is a disk. One semicircular portion of this disk is a transmission region 42, and the other semicircular portion is a reflection region 43. Note, however, that a region of the mirror wheel 41 other than a predetermined region including the center is a region which a driving motor as a rotation control means for the mirror wheel 41 overlaps, and is a range which is not used for transmission or reflection of light in the prior art.

In this embodiment, two light sources 51 and 53 are arranged such that the optical axes of exit light beams intersect each other. A collimator lens 52 is placed on the exit surface of the light source 51. A collimator lens 54 is placed on the exit surface of the light source 53.

In this embodiment, the intersecting portion between exit light beams from the light sources 51 and 53 falls within an effective range 47 of the mirror wheel 41.

A motor 55 rotates the mirror wheel 41 in synchronism with a video. When the transmission region 42 is located in an intersection range 57 of exit light beams from the light sources 51 and 53, the light source 53 is turned on, and exist light is transmitted through the transmission region 42 and is guided to a light bulb (not shown) through a light tunnel 56. When the reflection region 43 is located in the intersection range 57, the light source 51 is driven, and exit light from the light source 51 is reflected by the reflection region 43. As a result, the light tunnel 56 superimposes/averages the light by using the light cutoff angle. The resultant light is guided to the light bulb (not shown).

In this case, since the light sources 51 and 53 each have a finite shape and an exit divergence angle, an intersection range 44 formed on the mirror wheel 41 by exit light beams through collimator lenses 52 and 54 has a finite size. For this reason, in the region where the boundary portion between the transmission region 42 and the reflection region 43 crosses the intersection range 44, part of light from the light source 51 mixes with part of light from the light source 53. Alternatively, part of light from the light source 51 and part of light from the light source 53 are transmitted and reflected without being guided to the light tunnel 56. That is, the region which straddles the intersection range 44 described above becomes a limited light concentration range L1.

If dichroic mirrors 46 and 45 which reflect light from the light source 51 and transmit light from the light source 53 are arranged in the limited light concentration range L1 of the mirror wheel 41, light from either of the light sources 51 and 53 can be effectively guided to the light tunnel 56 in all the regions including the limited light concentration range L1.

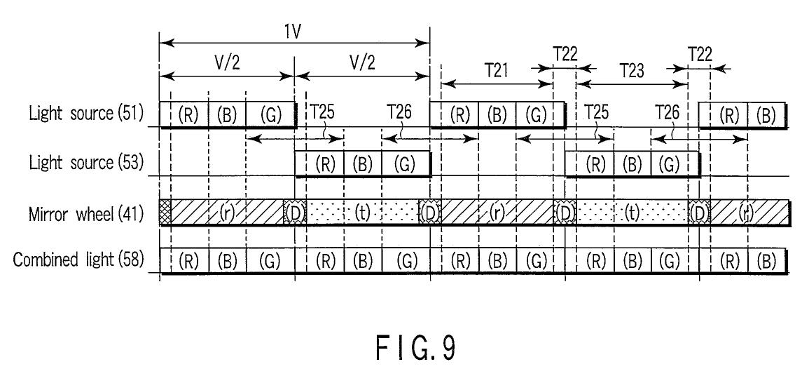

FIG. 9 is a timing chart showing the relationship between the emission period of each light source, the switching state of the respective regions of the mirror wheel, and the emission state of combined light of the display illumination apparatus according to the first embodiment of the present invention.

In this embodiment, the mirror wheel 41 synchronously rotates in a cycle 1V of a video sync signal. During a period V/2 which is half of the cycle 1V, the light source 51 is made to sequentially emit red (R), blue (B), and green (G) light beams in the order named. During a remaining period V/2, the light source 53 is made to sequentially emit red (R), blue (B), and green (G) light beams in the order named. In a period T22(D) centered on the emission switching timing between the light sources 51 and 53, the dichroic mirror 46 which reflects green light from the light source 51 and transmits red light from the light source 53 is placed in the intersection range 57. Alternatively, the dichroic mirror 45 which reflects red light from the light source 51 and transmits green light from the light source 53 is placed in the intersection range 57. A period “r” of the mirror wheel 41 shown in FIG. 9 is a period during which the reflection region 43 is placed in the intersection range 57, and a period “t” is a period during which the transmission region 42 is placed in the intersection range 57.

With this operation, in time T21 (=V/2), light from the light source 51 is reflected by the mirror wheel 41 and guided to the light tunnel 56. In time T23 (=V/2), light from the light source 53 is transmitted through the mirror wheel 41 and guided to the light tunnel 56. When integrated by the cycle 1V, light source beams from the light sources 51 and 53 can be combined with each other as if there were no time loss.

In this case, the ranges of the dichroic mirrors 45 and 46 need not coincide with the limited light concentration range L1, and may switch at either of the positions of reflection/transmission effective periods of the dichroic mirrors after the region of T22, i.e., emission period ranges T25 and T26 determined for each arbitrary color light source determined in consideration of optical characteristic conditions and the maintenance of white balance.

### SECOND EMBODIMENT

As described in the first embodiment, since the ranges of the dichroic mirrors provided for a limited light concentration range L1 of a mirror wheel 41 need not always be limited, the boundary can be set at the emitted light color switching timing of light sources 51 and 53. Setting the switching range at this position allows consideration of only narrowband characteristics associated with light emission during this period as the optical characteristics of a transmission region 42 and reflection region 43. This makes it possible to design a high-efficiency antireflection coat and reflection coat with a small number of films, i.e., at a low cost. Likewise, from the viewpoint of cost, in many cases, it is easier to design/manufacture a dichroic mirror with respect to red and blue spaced far in terms of wavelength than to design/manufacture a dichroic filter with respect to red and green adjacent to each other in terms of wavelength as in the first embodiment, when considering moderate transition characteristics.

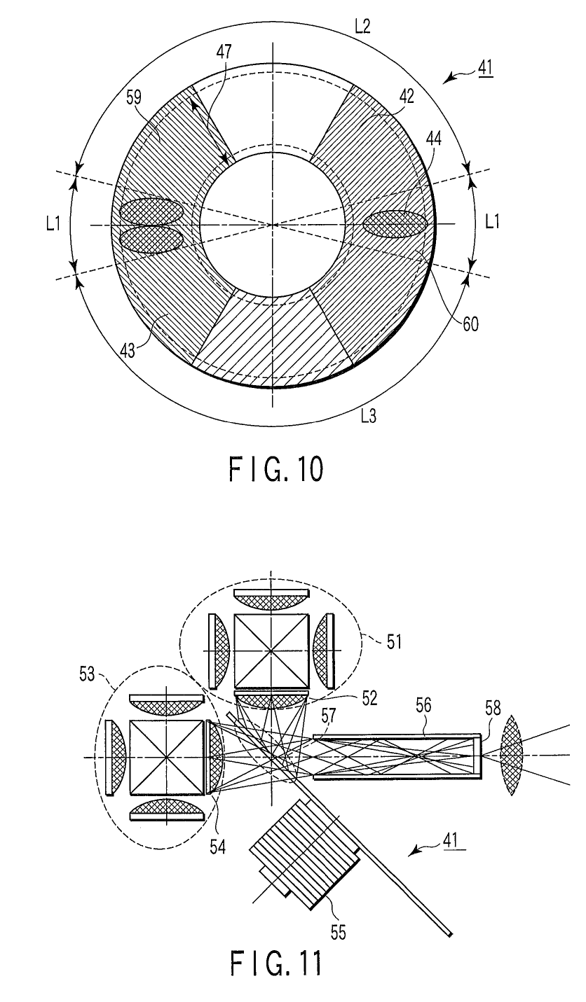

As shown in FIG. 10, this display illumination apparatus uses a mirror wheel 41 having a dichroic mirror 59 with a blue light reflection characteristic and a red light transmission characteristic and a dichroic mirror 60 with a blue light transmission characteristic and a red light reflection characteristic, which are wider than limited light concentration range L1 and arranged on the transmission region 42 and the reflection region 43. The overall arrangement of this apparatus is the same as that of the first embodiment shown in FIG. 11.

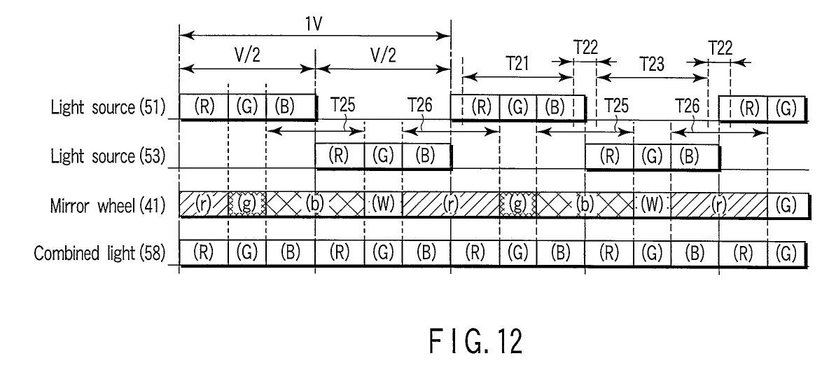

A period “b” of the mirror wheel 41 shown in FIG. 12 is a period in which the dichroic mirror 59 is placed in an intersection range 57. A period “r” is a period in which the dichroic mirror 60 is placed in the intersection range 57. A period “g” of the mirror wheel 41 shown in FIG. 12 is a period in which the reflection region 42 without any dichroic mirror is placed in the intersection range 57. A period “W” is a period in which the transmission region 42 without any dichroic mirror is placed in the intersection range 57.

As shown in the timing chart of FIG. 12, the light sources 51 and 53 are driven to emit red, green, and blue light beams in the order named and to position the dichroic mirror 59 in the intersection range 57 in a period T25 as the sum of the emission period of blue light from the light source 51 and the succeeding emission period of red light from the light source 53 and position the dichroic mirror 60 in the intersection range 57 in a period T26 as the sum of the emission period of blue light from the light source 53 and the succeeding emission period of red light from the light source 51. This makes it possible to construct an illumination system with high practicality by using a single-chip DLP projector when considering also the manufacturability of a general color wheel.

### THIRD EMBODIMENT

The third embodiment of the present invention will be described.

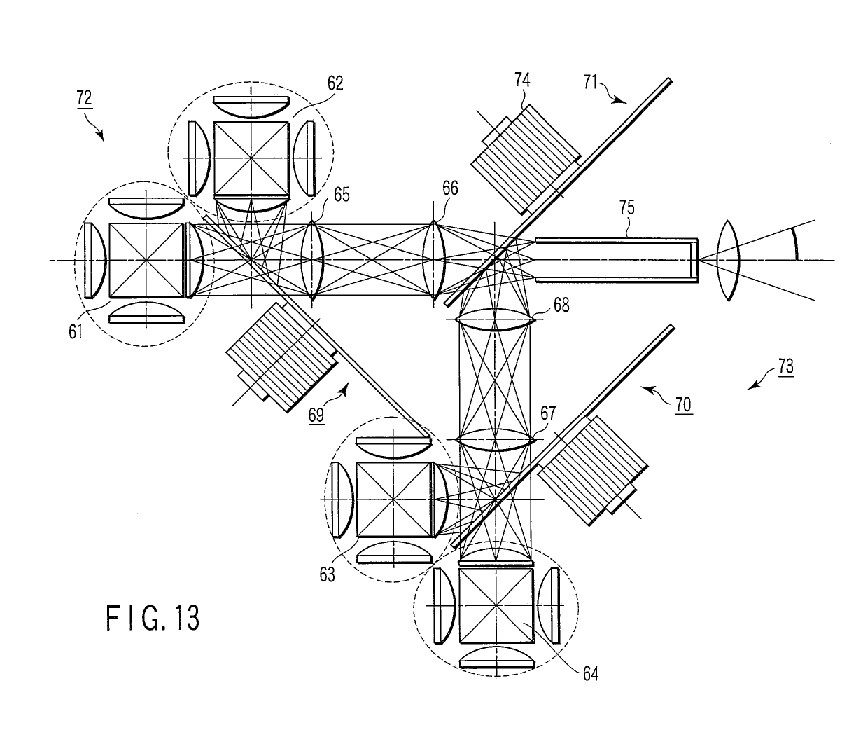

FIG. 13 is a plan view showing an example of the overall arrangement of a display illumination apparatus according to the third embodiment of the present invention.

The arrangement example shown in this embodiment is an arrangement example for constructing a high-output projector. In this embodiment, four light sources capable of obtaining light beams with maximum intensity, for which color combining operation corresponding to LED light source wavelengths, which is a conventional technique, is provided, are combined into two combinations each including two light sources by using the arrangement exemplified by the first and second embodiments, and the respective combined light sources, each as one unit light source, are further time-divisionally superimposed into one light source by using a mirror wheel.

More specifically, in this embodiment, combined light sources 61, 62, 63, and 64 are different types of light sources obtained by combining light beams of the three primary colors as shown in FIG. 2, and the combined light sources 61 and 62, a mirror wheel 69, the combined light sources 63 and 64, and a mirror wheel 70 respectively form single combined light source units 72 and 73 by using either the first embodiment or the second embodiment.

Relay lenses 65, 66, 67, and 68 relay the optical conditions of exit light beams from the combined light source units 72 and 73, and the resultant light beams intersect each other at an arbitrary effective surface of a mirror wheel 71.

Light from the light source unit 72 which has passed through the condenser lens 66 reaches a light tunnel 75 when the mirror wheel 71 is located in the transmission range. Light from the light source unit 73 which has passed through the condenser lens 68 reaches the light tunnel 75 when the mirror wheel 71 is located in the reflection range.

If, therefore, the emission periods of the combined light sources 61, 62, 63, and 64 each are set to almost half, and the respective combined light sources are arbitrarily driven in accordance with the regions of the mirror wheel 71, all emitted light beams pass through predetermined optical paths and reach the light tunnel 75. In addition, there is no loss between the respective switching timings within the range in which the limited light concentration range does not exceed the emission period of an arbitrary emitted light color light source.

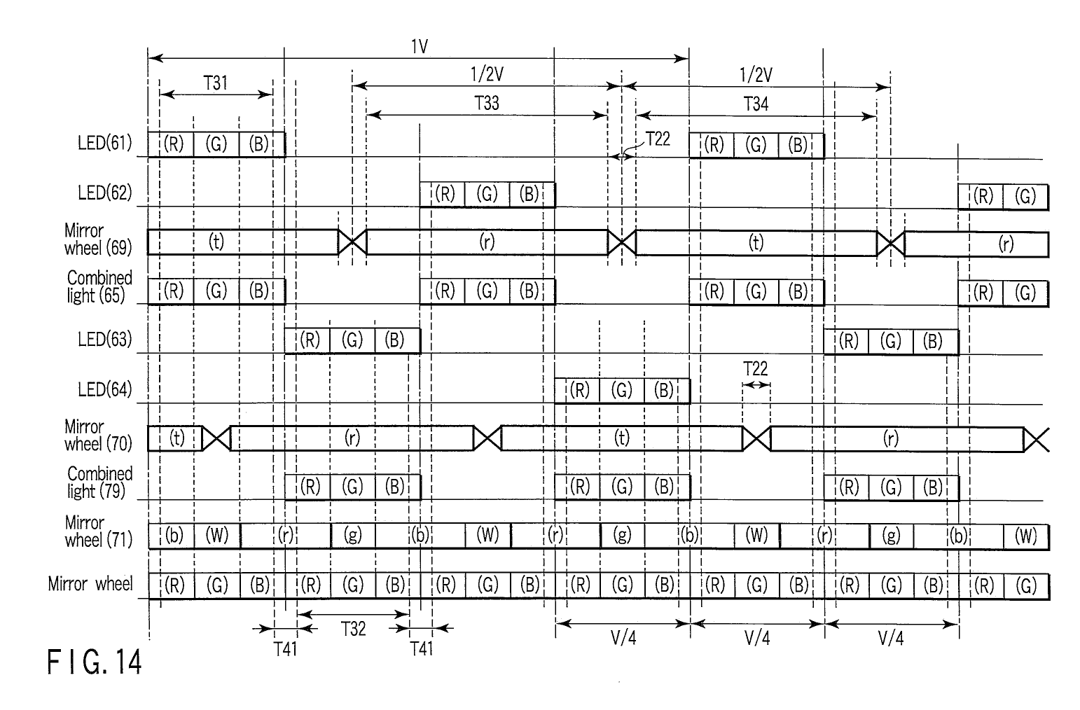

FIG. 14 is a timing chart showing the relationship between the emission period of each light source, the switching state of the respective regions of the mirror wheel, and the emission state of combined light of the display illumination apparatus according to the third embodiment of the present invention.

Assume that the arrangements of the mirror wheels 69 and 70 are the same as that of the mirror wheel 41 shown in FIG. 7 described in the second embodiment, and the arrangement of the mirror wheel 71 is the same as that shown in FIG. 10. The rotation cycle of the mirror wheel 71 is half of that of the mirror wheels 69 and 70.

In this embodiment, the light source units 61, 63, 62, and 64 sequentially emit light at equal intervals.

The region, of the regions of the mirror wheel 69, which is located between the light source units 61 and 62 switches from the transmission region to the reflection region at the intermediate time between the emission end time of the light source unit 61 and the emission start time of the light source unit 62.

The region, of the regions of the mirror wheel 69, which is located between the light source units 61 and 62 switches from the reflection region to the transmission region at the intermediate time between the emission end time of the light source unit 62 and the emission start time of the light source unit 61.

The region, of the regions of the mirror wheel 70, which is located between the light source units 63 and 64 switches from the transmission region to the reflection region at the intermediate time between the emission end time of the light source unit 64 and the emission start time of the light source unit 63.

The region, of the regions of the mirror wheel 70, which is located between the light source units 63 and 64 switches from the reflection region to the transmission region at the intermediate time between the emission end time of the light source unit 63 and the emission start time of the light source unit 64.

In addition, the region, of the regions of the mirror wheel 71, which is located between the relay lenses 66 and 68 at the intermediate time between the emission end time of the light source unit 61 and the emission start time of the light source unit 63 and at the intermediate time between the emission end time of the light source unit 62 and the emission start time of the light source unit 64 is the dichroic mirror 60 having a blue light transmission characteristic and a red light reflection characteristic as described above. The region, of the regions of the mirror wheel 71, which is located between the relay lenses 66 and 68 at the intermediate time between the emission end time of the light source unit 63 and the emission start time of the light source unit 62 and at the intermediate time between the emission end time of the light source unit 64 and the emission start time of the light source unit 61 is the dichroic mirror 59 having a blue light reflection characteristic and a red light transmission characteristic as described above.

More specifically, the light source unit 61 is made to emit red (R), green (G), and blue (B) light beams in the order named for time T31 in a rotation cycle 1V of the mirror wheel 69, and the mirror wheel 69 is rotated such that the transmission region (t) associated with a circumferential portion L2 (described above) of the mirror wheel 69 is located between the light source units 61 and 62 for time T34 including time T31.

In addition, the light source unit 62 is made to emit red, green, and blue light beams in the order named for time T31 at another timing after the lapse of a predetermined period from the emission end time of the light source unit 61 in a rotation cycle 1V of the mirror wheel 69, and the mirror wheel 69 is rotated such that the reflection region (r) associated with a circumferential portion L3 (described above) of the mirror wheel 69 is located between the light source units 61 and 62 for time T33 having the same length as that of time T34 including time T31. That is, the light sources 61 and 62 are alternately turned on at predetermined intervals.

In addition, the light source unit 63 is made to emit red, green, and blue light beams in the order named for time T32 after turning on of the light source unit 61 and before turning on of the light source unit 62 within another rotation cycle of the mirror wheel 70. The mirror wheel 70 is rotated such that the reflection region (r) associated with the above-described circumferential portion L3 of the mirror wheel 70 is located between the light source units 63 and 64 for time T32.

Furthermore, the light source unit 64 is made to emit red, green, and blue light beams in the order named for time T32 after turning on of the light source unit 62 and before turning on of the light source unit 61 within a rotation cycle of the mirror wheel 70. The mirror wheel 70 is rotated such that the transmission region (t) associated with the above-described circumferential portion L2 of the mirror wheel 70 is located between the light source units 63 and 64 for a time including time T32. That is, the light source units 63 and 64 are alternately turned on at predetermined intervals.

This causes combined light 65 to pass between the relay lens 65 and 66 during the on-time of the light source unit 61 and the on-time of the light source unit 62, and also causes combined light 79 to pass between the relay lenses 67 and 68 during the on-time of the light source unit 63 and the on-time of the light source unit 64.

Therefore, the final combined light is guided to the light tunnel 75 during an on-time T32 of the light source units 61, 62, 63, and 64.

As is obvious from the third embodiment, the combined light source unit obtained by applying the present invention has a property as a light source for next combining operation, which theoretically allows time-divisional combining of more light sources. The limit of this combining operation is determined by the maximum current standard of LEDs and the time during which the limited light concentration range determined by a mirror wheel is located between a plurality of light sources, which should be shorter than the driving time of a single light source based on detailed time-divisional driving.

### FOURTH EMBODIMENT

The fourth embodiment of the present invention will be described next.

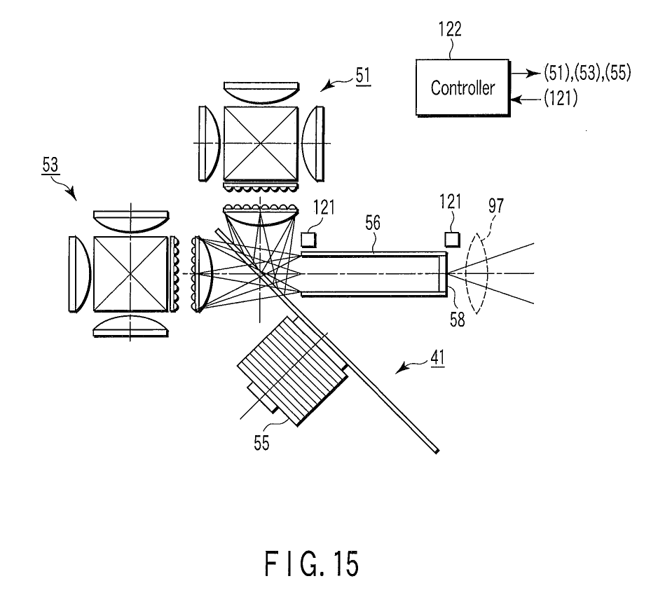

FIG. 15 is a plan view showing an example of the overall arrangement of a display illumination apparatus according to the fourth embodiment of the present invention.

This embodiment turns on only a single light source while stopping driving a mirror wheel in order to save power when the display illumination apparatus is battery-driven.

As shown in FIG. 15, the arrangement of the display illumination apparatus according to this embodiment differs from that shown in FIG. 1 in that a photosensor 121 is placed near the inlet of a light tunnel 56 or near a light bulb 58 when viewed from the light source. In practice, it suffices to place one of the photosensors 121. The photosensor 121 is a discrimination means for discriminating whether any of light beams from the light sources is guided to the light bulb.

When detecting a predetermined amount of light, the photosensor 121 discriminates that the reflection region of a mirror wheel 41 is located between light source units 51 and 53, and light from the light source unit 51 is guided to a light tunnel 56. Alternatively, the photosensor 121 discriminates that the transmission region of the mirror wheel 41 is located between the light source units 51 and 53, and light from the light source unit 53 is guided to the light tunnel 56. The photosensor 121 then outputs a signal indicating this discrimination to a controller 122.

The controller 122 is a driving means for causing only one of light source units 51 and 53 to emit light. The controller 122 has already recognized that one of the light source units 51 and 53 has currently emitted light. Upon receiving a signal from the photosensor 121 during the emission of light from the light source 51, the controller 122 discriminates that the reflection region of the mirror wheel 41 is located between the light source units 51 and 53. Upon receiving a signal from the photosensor 121 during the emission of light from the light source unit 53, the controller 122 discriminates that the transmission region of the mirror wheel 41 is located between the light source units 51 and 53.

Upon discriminating that the reflection region of the mirror wheel 41 is located between the light source units 51 and 53, the controller 122 stops driving a driving motor 55 upon always turning on the light source unit 51 and turning off the light source unit 53.

Upon discriminating that the transmission region of the mirror wheel 41 is located between the light source units 51 and 53, the controller 122 stops driving the driving motor 55 upon always turning on the light source unit 53 and turning off the light source unit 51. That is, the controller 122 functions as a rotation stop control means for stopping the rotation of an optical member upon switching to the power save mode.

Upon discriminating that the limited light concentration range of the mirror wheel 41 is not located between the light source units 51 and 53, the controller 122 drives the driving motor 55 until the reflection region of the mirror wheel 41 is located between the light source units 51 and 53. That is, the controller 122 is a control means for shifting the optical member by an arbitrary angle upon discriminating that light from neither of a plurality of light sources is not guided to the light bulb 58.

With such control, only light from the light source unit 51 is always guided to the light tunnel 56. Alternatively, only light from the light source unit 53 is always guided to the light tunnel 56. This makes it possible to greatly reduce the power consumption even though decreasing the brightness when viewed from the user.

### FIFTH EMBODIMENT

The fifth embodiment of the present invention will be described next.

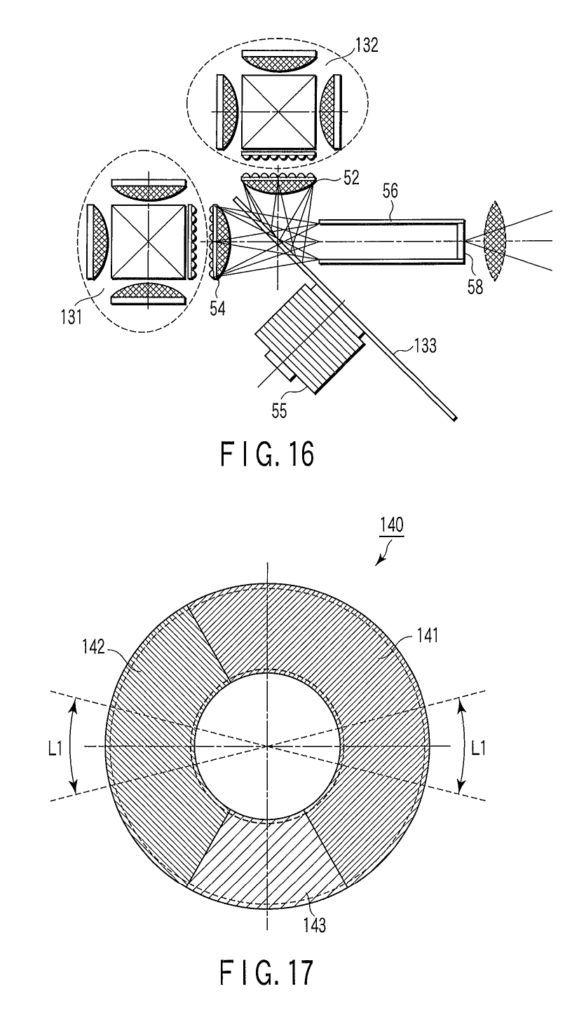

FIG. 16 is a plan view showing an example of the overall arrangement of a display illumination apparatus according to the fifth embodiment of the present invention.

As shown in FIG. 16, in the fifth embodiment, light sources 131 and 132 are used in place of the light sources 53 and 51, respectively, and a mirror wheel 133 is provided in place of the mirror wheel 41 as compared to the structure shown in FIG. 11.

FIG. 17 is a plan view showing a first example of the mirror wheel of a display illumination apparatus according to the fifth embodiment of the present invention.

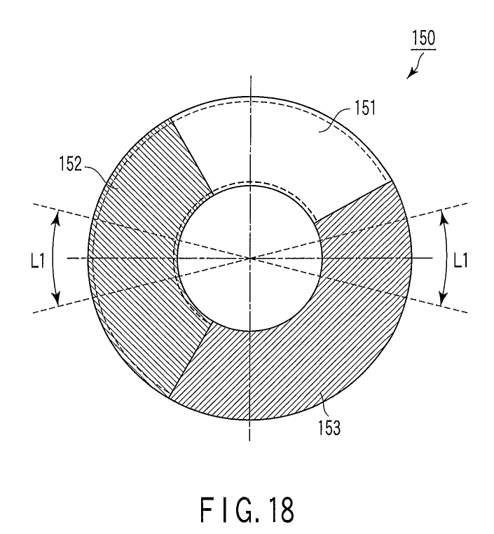

FIG. 18 is a plan view showing a second example of the mirror wheel of a display illumination apparatus according to the fifth embodiment of the present invention.

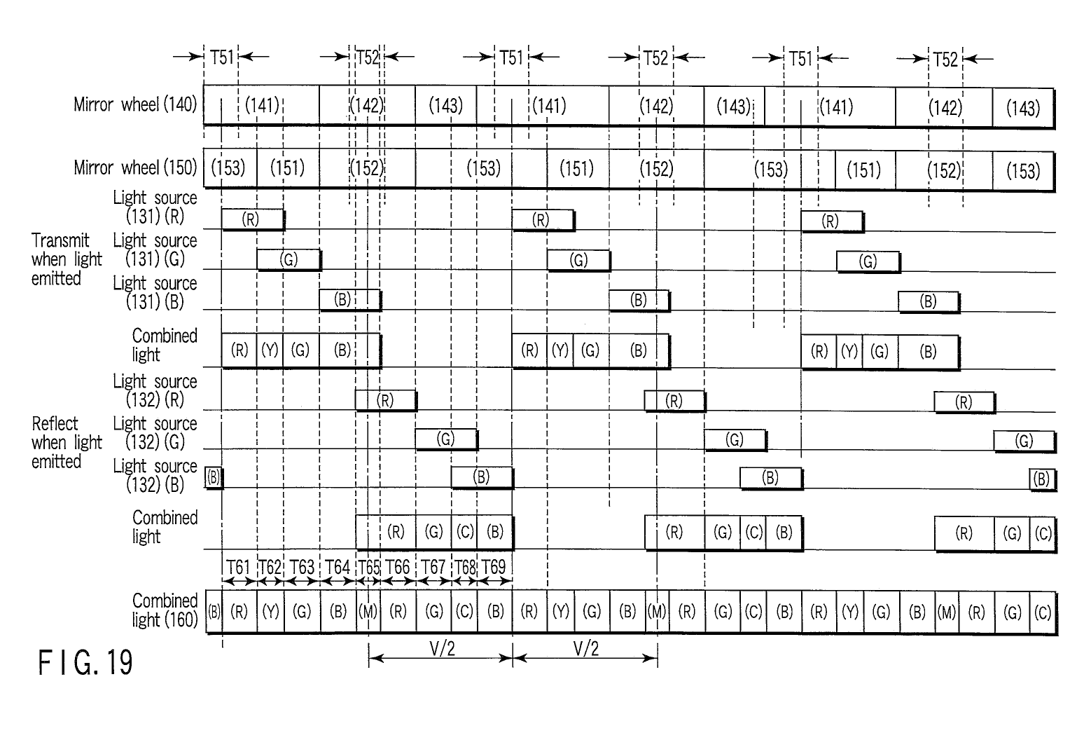

FIG. 19 is a timing chart showing the relationship between the emission period of each light source, the switching state of the respective regions of the mirror wheel, and the emission state of combined light of the display illumination apparatus according to the fifth embodiment of the present invention.

It should be noted here that a double of rotation directional component X of the limited light concentration crossing range, which has passed the collimator lenses 52 and 54 corresponds to L1 in FIGS. 17 and 18, and T51 and T52 in FIG. 19.

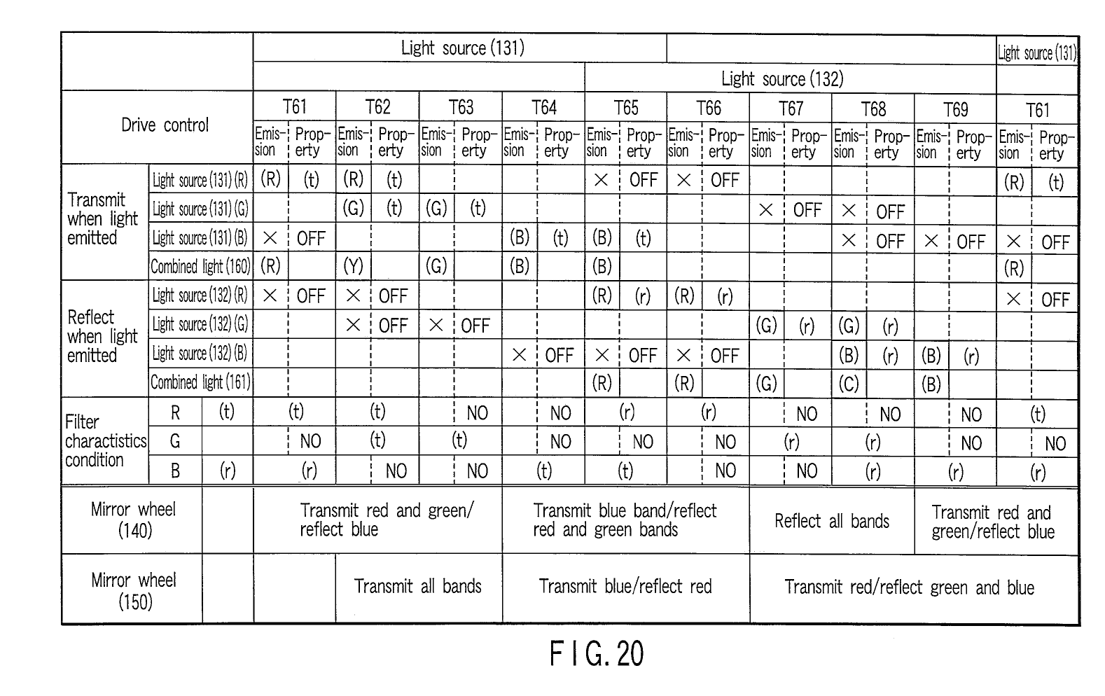

FIG. 20 is a diagram showing an example of the light emission conditions of each light source, and filter property conditions of the display illumination apparatus according to the fifth embodiment of the present invention.

In this embodiment, a mirror wheel 140 shown in FIG. 17 or a mirror wheel 150 shown in FIG. 18 are used as the mirror wheel 133

In the mirror wheel 140, along its counter-clockwise direction, a dichroic mirror 141 having blue light reflection characteristics and red light and green light transmission characteristics is provided in a region which straddles the limited light concentration range L1, a dichroic mirror 142 having red light and green light reflection characteristics and blue light transmission characteristics is provided in a region which straddles the limited light concentration range L1 and a reflection region 143 having reflection characteristics to the entire band is provided.

In the mirror wheel 150, along its counter-clockwise direction, a transmission region 151 having transmission characteristics to the entire band is provided, a dichroic mirror 152 having red light reflection characteristics and blue light transmission characteristics is provided in a region which straddles the limited light concentration range L1, the reflection region 143 having blue light and green light reflection characteristics and red light transmission characteristics is provided in a region which straddles the limited light concentration range L1.

The period “141” of the mirror wheel 140 shown in FIG. 19 is a period in which the dichroic mirror 141 is provided in the intersection range of light from each light source, the period “142” is a period in which the dichroic mirror 142 is provided in the intersection range of light from each light source, and the period “143” is a period in which the reflection region 143 is provided in the intersection range of light from each light source.

Further, the period “151” of the mirror wheel 150 shown in FIG. 19 is a period in which the transmission region 151 is provided in the intersection range of light from each light source, the period “152” is a period in which the dichroic mirror 152 is provided in the intersection range of light from each light source, and the period “153” is a period in which the dichroic mirror 153 is provided in the intersection range of light from each light source.

In this embodiment, as shown in the timing chart of FIG. 19, the light sources 131 and 132 are rendered to emit light in the order of red, green and blue.

However, the light emission periods of red light and green light of the light source 131 overlap for a certain period of time, and so do the light emission periods of blue light of the light source 131 and red light of the light source 132, and the light emission periods of green light and blue light of the light source 132.

Then, in a period T51, which is a total of the light emission period of blue light from the light source 132 and the following light emission period of red light from the light source 131, the dichroic mirror 141 of the mirror wheel 140 or the dichroic mirror 153 of the mirror wheel 150 is situated in the intersection range of light from each light source.

Further, in a period T52, in which the emission of blue light from the light source 131 and the emission of red light from the light source 132 overlap, the dichroic mirror 142 of the mirror wheel 140 or the dichroic mirror 152 of the mirror wheel 150 is situated in the intersection range of light from each light source.

Furthermore, in the light emission period of blue light from the light source 131 and the light emission period of red light from the light source 132, the dichroic mirror 142 of the mirror wheel 140 is situated in the intersection range of light from each light source. In the light emission period of green light from the light source 132, the reflection region 143 of the mirror wheel 140 is situated in the intersection range of light from each light source. In the other periods, the dichroic mirror 141 of the mirror wheel 140 is situated in the intersection range of light from each light source.

Furthermore, in the light emission period of green light from the light source 131, the transmission region 151 of the mirror wheel 150 is situated in the intersection range of light from each light source. In the light emission period of blue light from the light source 131 and the light emission period of red light from the light source 132, the dichroic mirror 152 of the mirror wheel 150 is situated in the intersection range of light from each light source. In the other periods, the dichroic mirror 153 of the mirror wheel 150 is situated in the intersection range of light from each light source.

With the above-described drive, red light is guided to the light tunnel 56 in the light emission period T61 in which the light source 131 emits only red light, yellow light is guided to the light tunnel 56 in the light emission period T62 in which red light and green light of the light source 131 overlap, green light is guided to the light tunnel 56 in the light emission period T63 in which the light source 131 emits only green light, and blue light is guided to the light tunnel 56 in the light emission period T64 in which the light source 131 emits only blue light.

Further, magenta light is guided to the light tunnel 56 as the combined light 160 in the light emission period T65 in which blue light of the light source 131 and red light of the light source 132 overlap, red light is guided to the light tunnel 56 in the light emission period T66 in which the light source 132 emits only red light, green light is guided to the light tunnel 56 in the light emission period T67 in which the light source 132 emits only green light, cyan light is guided to the light tunnel 56 as the combined light 160 in the light emission period T68 in which green light and blue light of the light source 132 overlap, and blue light is guided to the light tunnel 56 in the light emission period T69 in which the light source 132 emits only blue light.

In FIG. 19, the combined light 160 “(Y)” indicates that yellow light is emitted, and “(M)” indicates magenta light and “(C)” indicates cyan light.

In FIG. 20, “NO” indicates that the filter characteristics conditions are not particularly specified.

As described above, in this embodiment, yellow light, magenta light and cyan light of complimentary colors can be guided to the light tunnel 56, and therefore the light emission time of the three primary colors can be prolonged.

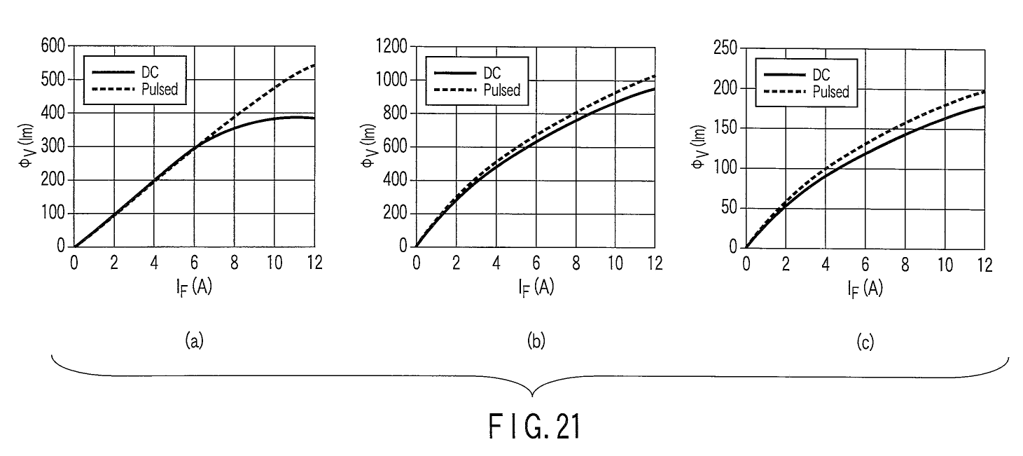

FIG. 21 is a diagram showing an example of the characteristics of the light emission efficiency of each light source of the display illumination apparatus according to the fifth embodiment of the present invention.

FIG. 21A shows the characteristics of the light emission efficiency of red color; FIG. 21B shows the characteristics of the light emission efficiency of green color; and FIG. 21C shows the characteristics of the light emission efficiency of blue color. In FIG. 21, the characteristic curve denoted by “DC” indicates the characteristics of light bundle with respect to the DC current, in which the light emission efficiency deteriorates as the current increases.

According to this embodiment, for example, when the control limit condition for the LED is the maximum current, the output light of the projector can be increased in terms of the emission light extension ratio. On the other hand, when the limit condition is thermal radiation, the lighting time at the same power consumption can be prolonged. In other words, the lighting current can be lowered. Therefore, for the same power consumption, the light emission efficiency of the element itself can be improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An illumination apparatus for a display, comprising:
first and second light sources;
a lighting control unit which lights the first and second light sources successively; and
a light path switching unit which switches light paths between each of the light sources and a projection lens among a first state in which light from the first light source of the first and second light sources is emitted to the projection lens, a second state in which light from the second light source of the first and second light sources is emitted to the projection lens, and a third state in which light from either one of the first and second light sources is emitted to the projection lens.

2. The illumination apparatus according to claim 1, wherein the light path switching unit includes an rotator which divides a reflection and transmission region which transmits the light from the first light source to the projection lens and reflects the light from the second light source to the projection lens in arbitrary angles, and locates the reflection and transmission region of the rotator in an intersection region of the light from the first light source and the light from the second light source in a period including switching timing between the lighting period of the first light source and the light period of the second light source.

3. A display illumination apparatus comprising:
a first light source which emits each of light beams of three primary colors for an arbitrary period in a predetermined period;
a second light source which emits each of the light beams of three primary colors for an arbitrary period in an arbitrary period different from the first light source emission period, with applied light intersecting applied light from the first light source;
a light bulb which receives light from one of the first light source and the second light source and outputs the light to a projection lens;
an optical member which is placed in an intersection region between light from the first light source and light from the second light source and on which a first region having a property of reflecting predetermined light from the first light source, a second region having a property of reflecting light of an arbitrary color from the first light source and transmitting light of a different arbitrary color from the second light source, a third region having a property of transmitting light from the second light source, and a fourth region having a property of transmitting light of an arbitrary color from the second light source and reflecting light of a different arbitrary color emitted from the first light source are arbitrarily arranged in a disk form; and
rotation control means for rotating the optical member to reflect light from the first light source toward the light bulb at the time of emission of light from the first light source, and locating each region of the optical member at an intersecting position between light from the first light source and light from the second light source so as to transmit light from the second light source toward the light bulb at the time of emission of light from the second light source.

4. The display illumination apparatus according to claim 3, wherein the optical member is a color wheel divided into four segments of red, green, blue, and transmission.

5. The display illumination apparatus according to claim 3, further comprising
the first light source unit which uses, as one unit, a light source device including the first light source, the second light source, the optical member, and the rotation control means,
a second light source unit which includes the first light source, the second light source, the optical member, and the rotation control means, and emits light in an arbitrary period different from an emission period of the first light source unit, with applied light intersecting applied light from the first light source unit,
a second optical member which is placed in an intersection region between light beams from the two light source units and on which a first region having a property of reflecting predetermined light from the first light source unit, a second region having a property of reflecting light of an arbitrary color from the first light source unit and transmitting light of a different arbitrary color from the second light source unit, a third region having a property of transmitting light from the second light source unit, and a fourth region having a property of transmitting light of an arbitrary color from the second light source unit and reflecting light of a different arbitrary color emitted from the first light source are arbitrarily arranged in a disk form, and
second rotation control means for rotating the optical member to reflect light from the first light source unit toward the light bulb at the time of emission of light from the first light source unit, and locating each region of the second optical member in an intersection region between light beams from the two light source units so as to transmit light from the second light source unit toward the light bulb at the time of emission of light from the second light source unit.

6. A display illumination apparatus comprising:
a plurality of light source units which include an optical member which is placed in an intersection region between applied light beams from a plurality of arbitrarily paired light sources and on which a first region having a property of reflecting light from one light source, a second region having a property of reflecting light of an arbitrary color from one of said plurality of light sources and transmitting light of a different arbitrary color from other of said plurality of light source, a third region having a property of transmitting light from the other light source, and a fourth region having a property of transmitting light of an arbitrary color from the other light source and reflecting light of a different arbitrary color emitted from one light source are arbitrarily arranged in a disk form, and rotation control means for rotating the optical member to sequentially apply light from the respective light sources through the optical member;
a light bulb which receives light from said each light source unit and outputs the light to a projection lens;
a second optical member which is placed in an intersection region between applied light beams from the respective light source units; and
second rotation control means for rotating the second optical member to guide light from said each light source unit to the light bulb in an arbitrary emission period of said each light source unit.

7. A display illumination apparatus comprising:
a first light source which substantially continuously and sequentially emits light beams of three primary colors in arbitrary periods in a predetermined period;
a second light source which substantially continuously and sequentially emits light beams in an order reverse to the first light source in an arbitrary period different from an emission period of the first light source, with applied light intersecting applied light from the first light source;
a light bulb which receives light from one of the first light source and the second light source and outputs the light to a projection lens;
an optical member which is placed in an intersection region between light from the first light source and light from the second light source and on which a first region having a property of reflecting predetermined light from the first light source, and a second region having a property of transmitting light from the second light source are arbitrarily arranged in a disk form; and
rotation control means for rotating the optical member to reflect light from the first light source toward the light bulb at the time of emission of light from the first light source, and locating each region of the optical member at an intersecting position between light from the first light source and light from the second light source so as to transmit light from the second light source toward the light bulb at the time of emission of light from the second light source.

8. The display illumination apparatus according to claim 3, further comprising
discrimination means, located between the optical member and the light bulb, for discriminating whether light from any of the first light source and the second light source is guided to the light bulb,
rotation stop control means for stopping rotation of the optical member upon switching to a power save mode,
driving means for causing only one of the effective first light source and the effective second light source which is discriminated by the discrimination means to emit light, and
control means for shifting the optical member by an arbitrary angle when the discrimination means discriminates that neither of first arbitrary light and second arbitrary light is not guided to the light bulb.

9. The illumination apparatus according to claim 1, wherein the first and second light sources emit light of three primary colors such that light emitting periods of predetermined colors of the three primary colors overlap for a predetermined period of time; and
The light path switching unit emits combined-light of the predetermined colors to the projection lens in the period in which the emitting periods of the predetermined colors overlap.
